(19) United States
(12) Patent Application Publication
(10) Pub. No.: US 2010/0223870 A1
(43) Pub. Date: Sep. 9, 2010

(54) Structural Member and Method of Manufacturing Same

(75) Inventor: Robert Keith Betts, Milford, OH (US)

Correspondence Address: WOOD, HERRON & EVANS, LLP, 2700 CAREW TOWER, 441 VINE STREET, CINCINNATI, OH, 45202, US

(73) Assignee: CINCINNATI THERMAL SPRAY INC., Cincinnati, OH (US)

(21) Appl. No.: 12/717,436

(22) Filed: Mar. 4, 2010

Related U.S. Application Data
(60) Provisional application No. 61/157,254, filed on Mar. 4, 2009.

(51) Int. Cl. E04B 2/16; E04B 1/66; E04C 2/20; E04B 1/74; B32B 21/04; B32B 7/02; B32B 27/00; C23C 4/00

(52) U.S. Cl. 52/309.1; 52/479; 52/515; 52/506.1; 428/192; 428/212; 428/141; 427/446; 427/189

(57) ABSTRACT

Provided is a system including a structural member for separating two environments that have different temperatures and a method of manufacturing the structural member. The system includes a barrier constructed with a plurality of the structural members. The structural member includes a core and a thermal barrier layer on at least a portion thereof. The thermal barrier layer is positionable between the two environments such that the structural member impedes the flow of heat and/or the flow of sound through the structural member and may improve a building's energy efficiency, occupancy comfort, and commercial viability.

### CROSS-REFERENCE TO RELATED APPLICATION

The present application claims priority to U.S. Ser. No. 61/157,254, filed Mar. 4, 2009, the disclosure of which is hereby incorporated herein by reference in its entirety.

### FIELD OF THE INVENTION

The present invention generally relates to a system for use in building construction, and, in particular, to a structural member for use in constructing walls in a building for increasing the resistance to the flow of heat into, out of, and/or through the building.

### BACKGROUND

The energy consumption associated with environmental control systems for buildings has become one focal point for development and application of “green” technologies and energy conservation. In particular, the energy consumption by a Heating Ventilating and Air Conditioning (HVAC) system that controls the temperature and other parameters of the inside areas of a building is associated with the construction of the building, specifically with the way in which the building is constructed and the materials from which it is constructed. For example, the outer wall of a building separates an outdoor weather temperature from an indoor, conditioned temperature. The materials in the wall determine, at least in part, the heat flow into and out of the building. The rate of heat flow from the hot to the cold side of the wall is driven by the thermal energy differential across the barrier and the heat flow path through the barrier from the hotter environment to the colder environment. As heat is lost from or gained by the temperature conditioned environment, the HVAC system uses energy to add or remove heat, respectively, from the conditioned temperature environment. For instance, heat lost from the inside of the building (e.g., during the winter season) through the wall must be replaced by the HVAC system. Similarly, heat gained by the temperature conditioned environment (e.g., during the summer season) must be removed by the HVAC system. As such, barriers to heat flow, such as the exterior walls of the building, are one primary medium that controls the inexorable flow of heat from the hot environment to the cold environment. The barrier, therefore, has a direct impact on energy consumption by the HVAC system. In general, reducing heat flow through the barrier reduces energy consumption.

The structure of a barrier, like the exterior wall, between two environments has an insulative value that is often referred to as the “R value.” The R value is a useful numerical rating of the wall's resistance to heat flow. R values are derived from the reciprocal of a “U value,” which is the effective thermal conductivity of the barrier. For example, the U value of a wall is the combined result of (a) the structure of the wall; (b) the thermal conductivity values (i.e., the heat energy transfer property of each individual material comprising of the structure of the wall) or k values of the components of the wall; and (c) the heat transfer mechanisms (e.g., conduction, convection, and radiation) through the solid/air pathways in the wall. The R value of a wall may be increased, for example, by adding bulk insulation to the wall that reduces the flow of heat due to at least one of the heat transfer mechanisms. For example, drywall and sheathing supported by framing members may form a part of a wall's outer surface and glass wool battens or blown or foamed insulation may be added to interior cavities that are bordered by the framing members and the drywall and the sheathing. In this case, the R value of the wall increases as a result of highly insulating nearly static air pockets formed by the solid insulation masses within the wall cavity, the barrier(s) to air flow, and insulating properties of the sheathing. However, all components of a barrier affect the overall R value of the barrier. Thus, the structural framing components of a building, e.g., studs, joists, rafters, beams, etc., which may be formed from wood and/or sheet metal, also contribute to the R value of the wall. Accordingly, these components contribute to the consumption of energy by HVAC system.

Because wooden and metallic portions of the wall, such as, wall studs and joists, have a lower R value than bulk insulation, significant heat transfer may occur through those studs and joists. For example, while wood is generally somewhat resistant to heat transfer, a wooden wall stud may still transfer heat through a wall approximately 3 times as fast as through glass wool insulation. Even more noteworthy, a steel-fabricated wall stud may be 1,000 times more heat conductive than glass wool insulation. Therefore, heat may flow into, out of, and/or throughout a building from the hotter to the cooler wall surfaces through the wooden or metal studs more quickly, essentially creating a “thermal bridge” that bypasses any insulation in the wall cavities. In this way, the actual R value of a wall may be 40-60% less than design R value due to heat loss through the wall principally due to heat flow through the wall studs.

Aside from the poor energy efficiency that may be associated with significant heat egress or ingress of a building, there are other problems that may be associated with rapid heat loss. For example, freezing damage may occur in the event of prolonged HVAC interruption or equipment failure due to overheating and/or human error. Further, in certain cold climates, rapid loss of heat through a wall stud or joist may result in localized cold regions on the interior wall surface that is in contact with structural member. In turn, this may cause localized condensation of humidity that may cause an undesirable appearance and, in certain instances, cause actual dampness on the wall that coincides with the underlying stud or joist. In a similar manner, wall studs or joists may promote the transfer of sound into, out of, and/or throughout a building's walls, floors, and/or ceilings.

Therefore, what is needed in the art is a system and a structural member to improve the energy efficiency of a building. In particular, what is needed in the art is a structural member having a reduced thermal conductivity that may be used in the construction of a building, that may reduce the consumption of energy by the HVAC system, and that may be durable. What is further needed is a method of manufacturing such a structural member that is both cost effective and sufficiently durable when exposed to normal construction site handling.

### SUMMARY OF THE INVENTION

In one embodiment, a structural member for use in constructing a barrier having a covering is provided. The barrier separates a first environment having a first temperature from a second environment having a second temperature. The structural member comprises a core of a first material having a first thermal conductivity, the core being adapted to support the covering and being used in constructing the barrier, and a thermal barrier layer of a second material disposed on at least one exterior surface of the core. The thermal barrier layer has a second thermal conductivity lower than the first thermal conductivity. The thermal barrier layer is positionable between the first environment and the second environment to reduce heat flow between the first and second environments.

In one embodiment, a method of manufacturing a structural member for use in constructing a barrier having a covering is provided. The barrier separates a first environment having a first temperature from a second environment having a second temperature. The method comprises applying a thermal barrier layer of a first material to a core of a second material. The first material has a thermal conductivity lower than that of the second material. The thermal barrier layer is positionable in the barrier between the first and second environments to reduce heat flow between the first and second environments.

In one embodiment, a system for use in constructing a building and that is configured to separate a first environment having a first temperature from a second environment having a second temperature is provided. The system comprises a barrier that is positioned between the first environment and the second environment. The barrier includes a plurality of structural members for supporting the barrier. The structural members each have a first side and a second side with at least one structural member that comprises a core of a first material and a thermal barrier layer of a second material that is disposed on the core and that coats at least one of the first and second sides of the structural member. The thermal barrier layer has a thermal conductivity that is less than a thermal conductivity of the first material. The first side of each structural member is oriented toward the first environment and the second side of the structural member is oriented toward the second environment. A first barrier covering is secured against the first sides of the plurality of structural members, and a second barrier covering is secured against the second sides of the plurality of structural members, whereby the thermal barrier layer is positioned between at least one of the core and the first barrier covering and the core and the second barrier covering.

### BRIEF DESCRIPTION OF THE DRAWINGS

The accompanying drawings, which are incorporated in and constitute a part of this specification, illustrate embodiments of the invention and, together with the brief description given above and the detailed description given below, serve to explain various aspects of the invention.

FIG. 1 is a perspective view of a structural member according to one embodiment of the invention;

FIG. 2 is a cross-sectional view of the structural member depicted in FIG. 1 taken along section line 2-2;

FIG. 3A is a perspective view of another embodiment of a structural member and illustrates one exemplary embodiment of applying a thermal barrier layer to a core;

FIG. 3B is a perspective view of another embodiment of a structural member with the thermal barrier layer detached from the core;

FIG. 4 is a partial-sectional view of a system according to one embodiment of the invention;

FIG. 5 is a schematic of a testing apparatus used to measure heat transfer; and

FIGS. 6A and 6B are photomicrographs taken at an original magnification of approximately 50× of a cross section of a sample of a low conductivity, thermal spray layer according to one embodiment of the invention.

### DETAILED DESCRIPTION

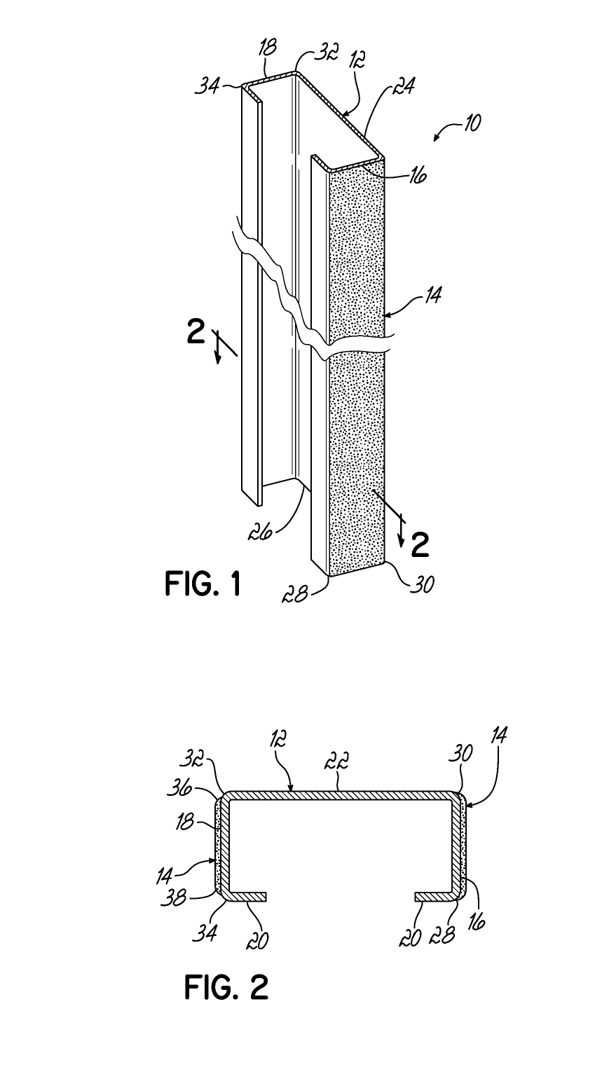

With reference generally to the FIGS. 1-4, and particularly to FIGS. 1 and 2, a structural member 10 according to one embodiment of the invention is depicted. As is described more fully below, the structural member 10 comprises a core 12 with a thermal barrier layer 14 disposed on at least a portion of the core 12. In one embodiment, the core 12 and the thermal barrier layer 14 are made of different materials where the material of the thermal barrier layer 14 has a lower thermal conductivity than the thermal conductivity of the material of the core 12. As such, the thermal barrier layer 14 may be made of an insulating material, as is described in more detail below. Where the thermal barrier layer 14 is positioned in a heat flow path between two environments having differing temperatures, the thermal barrier layer 14 impedes heat flow through the structural member 10. While the thermal barrier layer 14 may insulate the core 12 and thereby limit the flow of heat through the structural member 10, the thermal barrier layer 14 may also impede sonic waves from passing through the structural member 10. The materials of the structural member 10 and application methods may be environmentally “green” and may meet or exceed conventional building codes for structural safety, smoke generation, and fire retardation, among others.

The structural member 10 may be located in any part of a building (not shown) and may have appropriate configuration for a particular structural purpose. By way of example and not limitation, the structural member 10 may be included in a ceiling, in an interior or exterior wall, and/or in a floor or in another load bearing or non-load bearing structure in the building. As such, the structural member 10 may be dimensioned similar to standard dimensional lumber or other standard components used in construction. For instance, the structural member 10 may be dimensioned similar to a two-by-four, a four-by-six, or a ten-by-twelve, as are known in the art, to name only a few. In addition, the structural member 10 may form a portion of other components. For example, the structural member 10 may be configured as a track or other attachment device that may or may not have standardized dimensions for use with, for example, metallic framing members. In still another example, structural member 10 may support or otherwise contact a heating and/or cooling device and/or its associated ductwork as well as the building's water pipes and drains. Thus, it may reduce the heat flow to or from those components. As will be described in more detail below, a system that comprises a barrier to heat flow that may be used in constructing a building may be a composite assembly of many individual components that are made of different materials. For example, an exterior stud wall or other barrier that separates the interior, temperature controlled environment of a building from the uncontrolled weather outside of the building may be constructed of a plurality of structural members that support one or more air barriers, vapor barriers, drywall sheets, plywood sheets, chip board sheets, planking, flooring, corrugation, insulating sheathing, siding, shingles, brick, and/or other materials.

In the exemplary embodiment depicted in FIGS. 1 and 2, the structural member 10 may be configured as a wall stud, though the structural member 10 is not limited to this configuration, as set forth above. For example, member 10 may be a truss, a joist, a rafter, a beam, a window or door frame, a hanger, a fire-stop, a brace, or another part of a building's skeleton. As is known, a wall stud may form the internal supporting structure or skeleton of a wall that often supports and/or is supported by other structures that collectively form the building. For example, the wall may support a roof or a ceiling in the construction of buildings for residential and commercial use. In the embodiment shown, the structural member 10 has a generally rectangular cross section. As shown, a generally rectangular cross section need not form a complete rectangle. For example, the cross section may not form a closed shape, such as the generally C-shape shown in FIG. 2. Alternatively, the cross section may form a complete rectangle, such as that obtained by cutting a two-by-four of standard dimensions perpendicular to its long axis. However, it will be appreciated the structural member 10 may be any shape that provides the desired function as set forth herein.

With further reference to FIGS. 1 and 2, in one embodiment, the core 12 may be the primary load supporting structure of the structural member 10 and may generally form the cross-sectional configuration of the structural member 10. For example, as shown in FIGS. 1 and 2, the core 12 may have a generally rectangular cross section defined by pairs of opposing sides 16, 18 and 20, 22, where side 20 is discontinuous, and a first end 24 and a second end 26 that define a length of the structural member 10. Each side 16, 18 and 20, 22 may then be defined by a side edge, such as edges 28, 30, 32, 34, that extend the length of the core 12. It will be appreciated, however, that embodiments of the invention are not so limited, as the configuration of the core 12 and the thermal barrier layer 14 may be changed to suit a particular application.

The core 12 may be formed from any suitable material as will be apparent to one of ordinary skill in the art. By way of example, and with reference to the exemplary embodiment shown in FIGS. 1 and 2, the core 12 may be a sheet-metal framing stud made of a low-carbon steel or other appropriate metal that is made by bending a flat sheet of the steel into the C-shape configuration shown. As such, and where appropriate, the core 12 may be treated to protect the core 12 against degradation caused by exposure to the environment. For instance, the core 12 may be galvanized, aluminized, and/or painted to form a barrier over substantially all exposed surfaces thereof to prevent the core 12 from, for example, rusting.

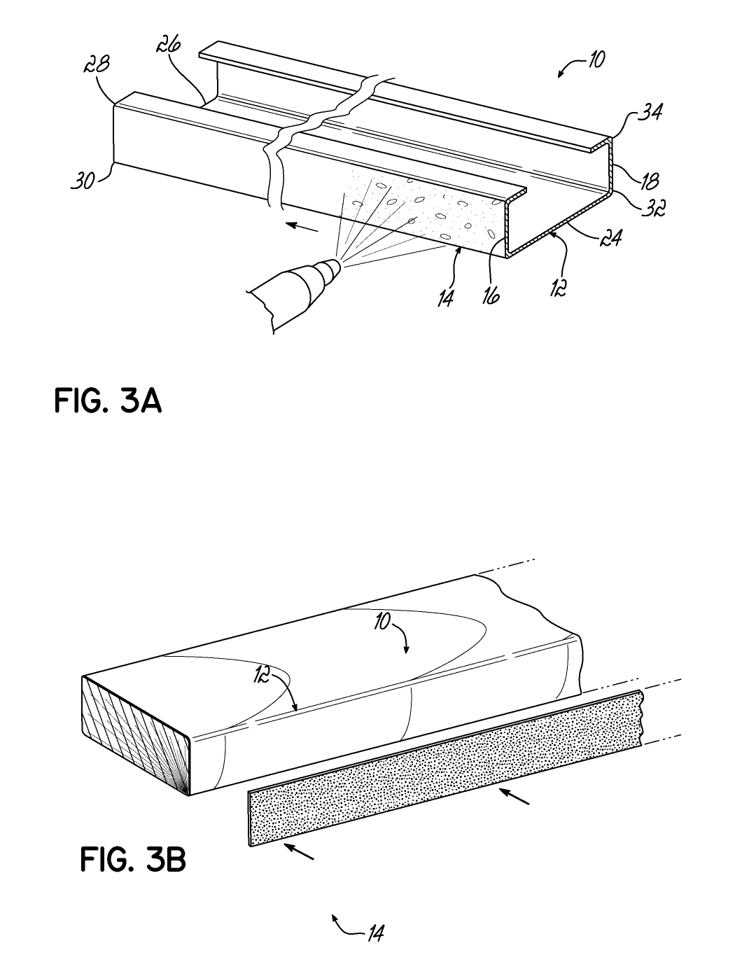

In one embodiment shown in FIG. 3B, the core 12 is made of wood. Accordingly, the core 12 may have a solid cross section and may also have dimensions similar to dimensional lumber used, for example, in residential construction. In this regard, a preservation treatment, to protect against exposure to the environment and/or insects, may be applied to the core 12. By way of further example, the core 12 may be a cast, pre-stressed concrete form; a brick; artificial or natural stone; or machined granite, or made of another suitable construction material or a combination thereof.

In yet another embodiment, while the core 12 may have a smooth surface, the core 12 may have a surface that has a specific texture or topography that may include peaks, ridges, and valleys that reduce the effective contact surface area between the core 12 and the thermal barrier layer 14 thereby creating “dead air” spaces that impede heat and/or sound flow. However, it will be appreciated that other regular or irregular surface topography or textures may allow the thermal barrier layer 14 to bridge across the deeper features of the topography of the core 12 and create pockets beneath the core 12 and the thermal barrier layer 14. In this regard, the thermal conductivity of the structural member 10 may be further reduced because of the reduced contact area between the core 12 and the thermal barrier layer 14.

With reference to FIGS. 1 and 2, and as set forth above, the layer 14 covers at least a portion of the outer surface of the core 12. For example, and with reference to FIG. 2, the layer 14 may cover one or more of the sides 16, 18, 20, and 22 of the core 12. In particular, as shown, the layer 14 may substantially extend from the side edge 28 to the side edge 30 on side 16. In addition, or alternatively, the layer 14 may cover only a portion of the respective side. For example, and with continued reference to FIG. 2, the layer 14 may be defined by layer side edges 36, 38 such that a width of the layer 14 measured from layer side edge 36 to layer side edge 38 is less than the distance across the side 18. In other words, the distance between layer side edge 36 and layer side edge 38 is less than the distance between side edge 32 and side edge 34 of side 18. In a similar manner, the layer 14 may not extend the full length of the core 12. In this case, the surface area of the layer 14 that forms the contact surface between the structural member 10 and any wall or barrier coverings, as set forth above and described in more detail below, is less than the contact surface where a wall covering is secured against a comparably dimensioned wall stud. In this way, further reduction in the heat flow through the structural member 10 between the opposing environments may be achieved.

In one embodiment, as with the topography of the core 12, described above, the surface of the layer 14 may have a roughness or topography sufficient to limit the contact between a wall covering and the structural member 10. The topography of the surface of the layer 14 may depend upon how the layer 14 is formed, as described below. By way of example, the layer 14 may be smooth or may be rough, such as being pebbled, dimpled, pocked, fissured, ridged, crackled, to name only a few. Such surface topography or profiling may be produced, with a particular coating application technique, by molding, or other forming operation and/or by adding other materials. These features may be used in combination with the topography or surface texturing of the core 12, described above. In one embodiment, topography of the layer 14 may have a predetermined design including having a unique color and/or pattern, applied design, or other surface features. For example, the layer 14 may have a topography that identifies the manufacturer, architect, or builder by name or by trademark. In these ways, insulative spaces, such as, bubbles, pockets, gaps and other discontinuities may be induced at the interface between the core 12 and thermal barrier layer 14 and/or between the thermal barrier layer 14 and any wall covering secured against the structural member 10. In one embodiment, the thermal barrier layer 14 includes internal porosity that inhibits heat flow through the structural member 10. By way of example, the insulative spaces within the thermal barrier layer 14 may be formed by the process parameters used when the thermal barrier layer 14 is applied, such as, with variation in the chemistry of the thermal barrier layer 14 or by incorporating beads, particulates, or other fillers in the thermal barrier layer 14 during or following application of the layer 14. In these embodiments, the filler may therefore be dispersed in the thermal barrier layer 14 and/or be attached to the thermal barrier layer 14. It will be appreciated that internal porosity, fillers, and surface topography of the core 12 and/or the layer 14 may be used in any combination.

The layer 14 may be of any suitable thickness or depth, though the layer 14 may be limited by the application technique or final design parameters. For example, layer 14 may be in a range from about 0.005 inch to about 0.500 inch thick, in the range of about 0.040 inch to about 0.250 inch thick, or in the range of about 0.080 inch up to about 0.125 inch thick. In another example, the thickness of the layer 14 may not be constant along the length and/or across the width of a side of the core 12. However, the thickness of the layer 14 is not so limited and may depend upon the particular material of the thermal barrier layer 14, the use for the structural member 10, and/or the material of the core 12.

Additionally, the layer 14 may be sufficiently strong such that it resists being crushed or compressed under normal loads associated with attachment of wall coverings, and it remains sufficiently flexible such that is does not flake or spall off of the core 12. That is, the layer 14 may be sufficiently robust such that the layer 14 may remain adherent and intact on the core 12 when subject to rigors of manufacturing and construction operations, such as when impacted, handled, cut, banded together, drilled, pried against, etc. The layer 14 may furthermore be resistant to water and other chemicals. For example, the layer 14 may not be substantially compressed when a sheet of dry wall is secured thereto with dry wall screws normally used to hang dry wall. In these applications, the layer 14 may substantially retain its predetermined or applied thickness, and may not require any on-site re-application and/or thickness adjustment. Advantageously, any predetermined specifications for the layer 14, i.e., thickness, coverage, texturing, and other structural characteristics, which collectively achieve a predetermined R value of the structural member 10, may be retained to meet or exceed industry standards. It will be appreciated that the size or dimensions of the core 12 may be adjusted to accommodate a specific predetermined R value by allowing an increase or decrease in the thickness of the thermal barrier layer 14 while providing the structural member 10 with standardized dimensions. For example, if a thermal barrier layer 14 that is about 0.500 inch thick is attached to two edges of the core 12, the width of the core 12 may be reduced by about 1 inch to keep the width of the structural member 10 at a nominal 4 inches or to match other industry standard dimensions.

As set forth above, the thermal barrier layer 14 is a material having a lower thermal conductivity than the material of the core 12. In one embodiment, the thermal barrier layer 14 is any suitable insulating material that provides an increase in the R value of the structural member 10. In this regard, the thermal barrier layer 14 impedes heat flow through the structural member 10 when the structural member 10 is positioned such that thermal barrier layer 14 resides between the core 12 and one or both of the environments that are separated by the structural member 10. By way of example, the thermal barrier layer 14 may be a material having relatively high thermal resistance and sonic insulation properties. For instance, the thermal barrier layer 14 may comprise a polymer, such as, polyethylene, polyurethane, polypropylene, polyamide, or polyester, or a combination thereof. By way of additional example, the layer may be an epoxy. Such polymers may be represented, though not limited to common trade-named products as Styrofoam®, Kevlar®, Nomex®, Lexan®, Plexiglas®, Teflon®, Nylon 6®, or Rilsan®. However, it will be appreciated that other thermoplastic or thermosetting polymers may also be used. Furthermore, the layer 14 may be in a solid form, in the form of porous foam, in the form of a composite comprising a combination of materials, or in another insulative-enhancing form. For example, a polymer layer may include one or more common filler materials, such as a mineral, like vermiculite, or other insulating material in particulate or fiber form or in another insulating form, for example, solid or hollow spheres, HOSP® powder, solid or hollow fibers, porous particulates, fragmented particulates, or pellets, to name only a few, which when dispersed in, composited into, and/or impinged onto or otherwise attached to the thermal barrier layer 14, may increase insulative properties thereof. In another example, layer 14 may be thermally sprayed ceramic oxides of zirconium or aluminum, or may comprise glass, one or more ceramics (e.g. oxides and nitrides), or minerals, or glass.

As set forth above, the layer 14 is made of a material that has a lower thermal conductivity than the thermal conductivity of the material of the core 12, for example, polyethylene foam has a thermal conductivity k value of approximately 0.114 BTU-[in]/hr-ft²-° F. and a related reciprocal insulative R value of around 8.770 hr-ft²-° F./BTU. Materials of the core 12, for example, pine wood and plain C-steel 1020, are characterized by thermal conductivities of about 0.828 BTU-[in]/hr-ft²-° F. and about 324 BTU-[in]/hr-ft²-° F., respectively. As such, the layer 14 may have a thermal conductivity that is a fraction of the core 12. Accordingly, in one embodiment, the thermal barrier layer 14 has a thermal conductivity that may be 25% or less than that of the core 12, though the thermal conductivity of the thermal barrier layer 14 may be less than about 15% of the core 12. However, the thermal conductivity of the thermal barrier layer 14 may be greater than or equal to the thermal conductivity of air that is about 0.114 BTU-[in]/hr-ft²-° F.

According to another embodiment of the invention, the structural member 10 may be made by applying the thermal barrier layer 14 to a side of the core 12, each described above, in any suitable manner. With reference to FIG. 3A and by way of example, the thermal barrier layer 14 may be formed by application of particulates of material directly onto the core 12 or by other coating techniques, such as, by a thermal spray process. A thermal spray process may be utilized to apply many of the materials listed above onto the surface of the core 12 to form the thermal barrier layer 14. Thermal spraying may include injecting the material of the thermal barrier layer 14 into a hot zone to heat the material and to project the heated material onto a surface. For example, a thermo-plastic polymer, such as, polyethylene in powder, wire, or rod form, may be fed through a thermal spray process. The thermal spray process heats, and may melt, the polymer by exposing the polymer to heat from gas combustion or from a radiation source, such as, an electrically heated wire. The powder, wire, or rod of material may be fed into the hot zone by a powder feeder or other means of controlling the amount of material that enters the hot zone as a function of time or other parameter. The process then projects the heated particles of the polymer onto a surface of the core 12. The heated or melted particles may stick or otherwise adhere to the core 12. Once the sprayed layer cools or solidifies, it may mechanically or chemically bond to the surface of the core 12 to form the thermal barrier layer 14. Suitable thermal spray equipment may be commercially available from Sulzer Metco, Westbury, N.Y., such as the Sulzer Metco 3M™ electric arc plasma heated gun and the Sulzer Metco 6P™ acetylene-oxygen combustion-fired gun and associated equipment, and other commercially available equipment may include that which may be available from XIOM® Corporation, West Babylon, N.Y., such as the XIOM® X1000™ model propane-oxygen combustion spray system. As is known, the thermal barrier layer 14 may be formed by applying a single layer of material in a single pass or may be the result of overlapping many individual layers on the core 12 during multiple spray passes. It will be appreciated that where the thermal barrier layer 14 comprises a plurality of sprayed layers, the thermal barrier layer 14 may comprise a plurality of materials. Furthermore, spray processes may not provide a well defined edge, such that, for example, the edges 36, 38 of FIG. 2 may not form sharp edges due to overspray or other inherent inaccuracies associated with spraying.

By way of additional example, the thermal barrier layer 14 may be applied by other powder coating techniques known in the art where polymer powder particles may be attached to the surface of the core 12 by electrostatic “cling.” The attached particles and/or the core 12 may then be heated in a conventional oven, for example, via infrared or ultraviolet radiation or with electric induction, to melt the particles or otherwise chemically convert the attached polymer particles into the thermal barrier layer 14. While applying the thermal barrier layer 14 to the core 12 may be achieved by the aforementioned methods, embodiments of the invention are not so limited, as other techniques, such as atomic force or cold spray processes (e.g. those processes that rely on kinetic energy or the velocity of particles to form a coating) or other methods of adhering particles of the material of the thermal barrier layer 14 to the core 12 may be utilized.

By way of further example, a polymer or other low thermal conductivity ingredient in liquid form or solid form contained in a suspension may be applied by a paint spraying process to form a coating on the core 12. As referred to herein, “coating” may also constitute a surface conversion whereby one material may be applied to the side of the core 12 and a subsequent physical or chemical modification of the coating occurs to form the thermal barrier layer 14. The thermal barrier layer 14 may then be formed following, for example, evaporation or chemical reaction of the sprayed coating. A material may also be applied to the core 12 by coating with a brush, a roller, a putty knife or other similar tool or by extruding a material onto the core 12 to form the thermal barrier layer 14. In another example, the core 12 may be dipped into a liquid or a solid-state fluidized bed to form a coating thereon such that following evaporation, thermal treatment, and/or chemical reaction, the thermal barrier layer 14 is formed. It will be appreciated that other application techniques are contemplated, such as, coating the core 12 by physical vapor deposition (PVD) or chemical vapor deposition (CVD) techniques, with a sol-gel precursor, and other similar techniques.

In one embodiment, the thermal barrier layer 14 may be formed by intentional conversion of a portion of the side of the core 12 or on all sides thereof to form the thermal barrier layer 14. This may be achieved by treating the core 12 to form a surface layer having different chemistry. For example, wood cores may absorb chemicals and/or solids to form the thermal barrier layer 14. By way of additional example, metallic cores may be chemically or metallurgically reacted to form a surface layer of an oxide, a nitride, or another composition that has a lower thermal conductivity than the material of the core 12. This result may be achieved by placing the core 12 in a controlled atmosphere, such as, a vacuum atmosphere and/or other specific reactive atmospheres, and then heating the core 12 to react the atmosphere with the core 12 to form the thermal barrier layer 14. For example, the process may include a pack cementation process or another reactive method that modifies the surface of the core 12 by additive thickening and/or atomic lattice penetration to produce the thermal barrier layer 14.

With reference to FIG. 3B, in one embodiment, the structural member 10 may be formed by attachment of a preform of the thermal barrier layer 14 to the core 12. Accordingly, applying the thermal barrier layer 14 may include direct bonding of the preform to the core 12 by an adhesive that is pre-applied to the core 12 or to the thermal barrier layer 14, or by means of chemical reaction, for example, by a change in the temperature of the core 12 or thermal barrier layer 14 or both or by anaerobic or similar assisted adhesion methods. By way of additional example, a thermo-setting polymer, two-part component epoxy, foam, paper or other appropriate thermal insulative strip may be applied directly to or preformed and attached to the core 12 to form the structural member 10. In addition, the thermal barrier layer 14 may be screwed, stapled, nailed, banded, bolted, riveted, glued, welded, or bonded to the core 12 by other fasteners or means known in the art to form the structural member 10. For example, a glass wool batten having insulated tabs and/or ordinary paper tabs may be stapled to or wrapped around the core 12 to cover at least one of the sides 16, 18, 20, and 22. In another example, thermal barrier layer 14 may be a pre-formed cover that is snapped around or otherwise attached to the core 12.

It will be appreciated that any of the aforementioned application processes may be implemented in an automated system. For example, the thermal barrier layer 14 may be thermally sprayed onto the core 12, as shown in FIG. 3A, to form the structural member 10 where application of the layer 14 may occur prior to, during, or following the forming of the core 12. Specifically, for a metallic structural member, the layer 14 may be sprayed onto a sheet of metal prior to the bending and cutting thereof to form the structural member 10. It is also envisioned that multiple thermal spray systems may be utilized to apply the layer 14 to a preform of a core that is subsequently formed into its final shape. Alternatively, two or more thermal spray processes may be used to apply layers to opposing surfaces of an already formed core, which may be configured as a metallic or wooden wall stud.

Furthermore, embodiments of the invention may include preparation of the surface of the core 12 prior to applying the thermal barrier layer 14. Such surface preparation processes may include degreasing and surface roughening by grit blasting or other surface activation processes known in the art. Other associated processes may include pre-heating to facilitate rapid application of the layer 14 and adherence of the layer 14 to the core 12. Further, post-coating air jets or other means may be used to rapidly cool and solidify the heated material.

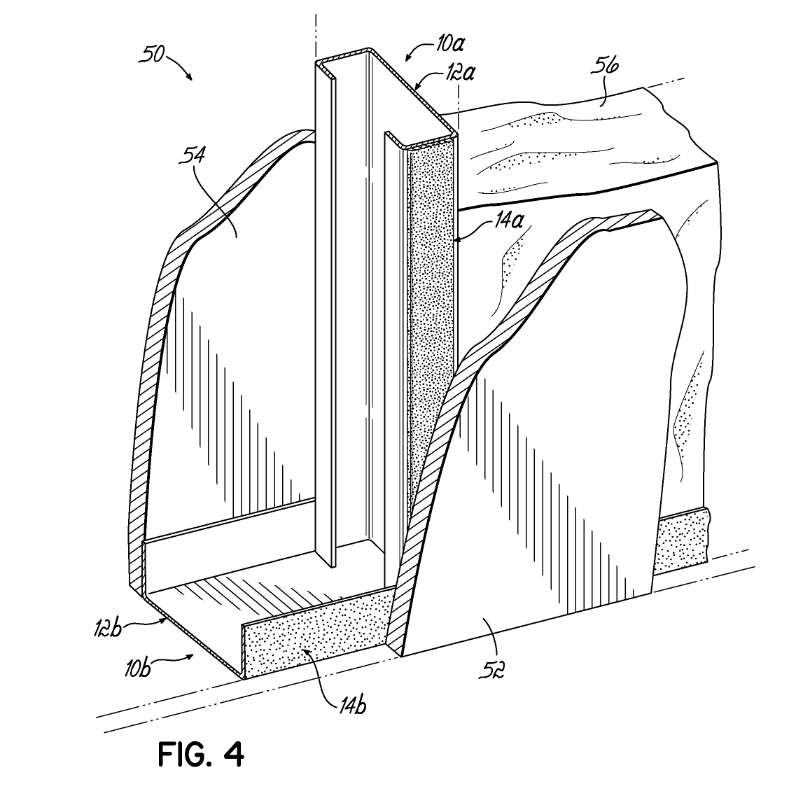

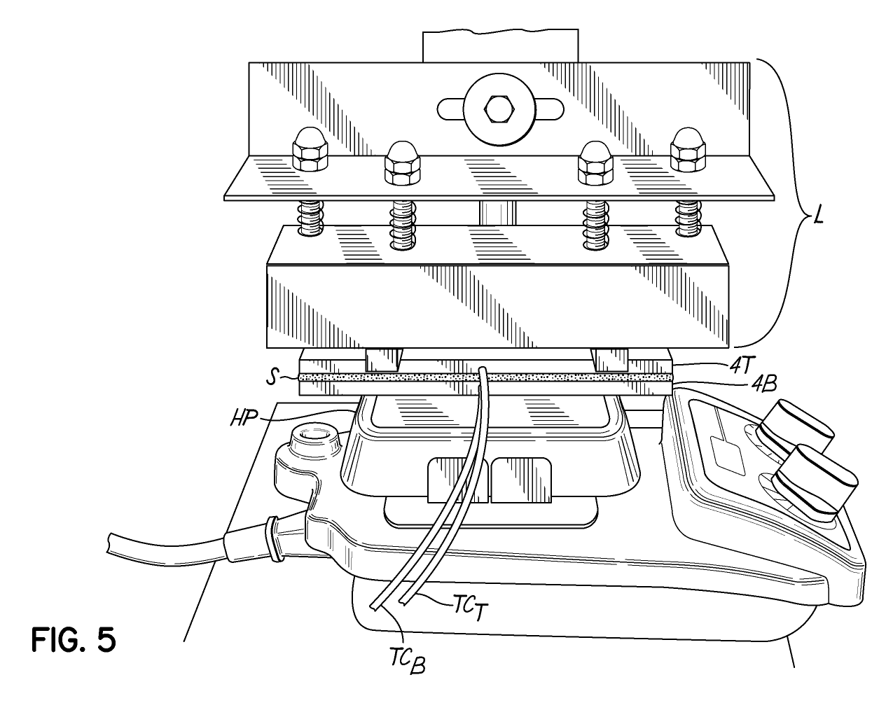

With reference to FIG. 4, in another embodiment of the present invention, a system 50 for use in constructing a building and that is configured to separate two environments having different temperatures is depicted. As shown in FIG. 4, the structural member 10 is configured to form a portion of the system 50, such as, a wall or other structural barrier, that separates two environments. In this regard, the structural member 10 improves the R value of the system 50 and thereby reduces the heat flow rate between the two environments that are separated by the system 50. In the exemplary embodiment illustrated, the system 50 is an exterior stud wall that may separate a temperature controlled environment from the uncontrolled weather environment. However, it will be appreciated that the construction may be more complex, such as, a multilayered structure, a window frame, a floor joist, a ceiling rafter, or other barrier found in a building and that separates two environments that have different temperatures and that forms a barrier to heat flow between the two environments. In the embodiment shown in FIG. 4, a first structural member 10a is oriented vertically and a second structural member 10b is oriented horizontally, collectively members 10a and 10b form the load bearing support of the system 50. However, it will be appreciated that the system 50 may contain additional structural members 10. A first barrier or wall covering 52 is secured against the structural members 10a, 10b, and a second barrier or wall covering 54 is secured against the opposing side of structural members 10a, 10b. A batten of insulation 56 may fill the space between the first and second barrier covering 52, 54. The first and second barrier coverings 52, 54 may be sheets of drywall or one or the other of the barrier coverings 52 and 54 may be an external insulative sheathing material. While the system 50 is depicted as having a single barrier covering on each side of the structural members 10a, 10b, the system 50 may include additional barrier coverings. For example, to reduce penetration of moisture from the interior, temperature controlled environment into the system 50, a vapor barrier (not shown) may be secured to the members 10 between the barrier covering 52 and the member 10. As is known, a vapor barrier may be a thin sheet of plastic, typically polyethylene, that is a few thousandths of an inch thick, that is often stapled to the studs and that generally extends the entire length and height of the wall. By way of further example, the system 50 may include other wall coverings on the opposing side of the member 10 including an air barrier (not shown) between the external sheathing and the member 10. In this regard, the barrier coverings 52, 54 may be secured to each of the structural members 10 with an appropriate fastener, for example, with drywall screws. Accordingly, thermal barrier layer 14 of the structural members 10 form the contact surfaces between the members 10a, 10b and the barrier covering 52. It will be appreciated that the thermal barrier layer 14 may also form the contact surface between the structural member 10 and both of the barrier coverings 52, 54 such that both sides 16 and 18 of the core 12 have a thermal barrier layer 14 thereon as shown in FIG. 2. In other more complex systems, member 10 may abut and/or be attached to any other suitable structure, for example, by edge facing or web lapping. It will be appreciated that the transfer of heat and/or sound originating in the environment adjacent to the barrier coverings 52, 54 may be reduced, dampened, or prevented altogether from passing through the system 50.

Furthermore, it will be appreciated that a layer of material may alternatively, or in combination with the structural member 10, described above, be applied to either or both surfaces of the barrier covering 52, 54 in FIG. 4. In this regard, a layer of material may be applied in approximate position to coincide with wall studs, for example. Thus, layers of material may be applied in a position to coincide with wall studs or other load bearing structure to reduce heat and sonic transfer.

In order to facilitate a more complete understanding of the invention, the following non-limiting examples are provided.

### Examples

Structural members and applied coating samples, according to embodiments of the invention were tested to demonstrate the performance characteristics thereof. The test determined heat transfer reduction between two thermocouple-instrumented aluminum alloy bars when respective samples were placed between the bars.

A schematic of the testing apparatus is shown in FIG. 5. A laboratory-type hotplate HP was fitted with a surrounding insulative box (not shown) thereby containing the heat from the hotplate HP to expose two test bars. The test bars, labeled 4B and 4T, were 1 inch×6 inches×¼ inch and were made of aluminum. Wells for thermocouples (TC_{B} and TC_{T} for bar 4B and 4T, respectively) were drilled at about 3 inches from the end of the each bars (i.e., in approximately the center of the bar). By the inserted thermocouples TC_{B} and TC_{T}, the temperature of each bar 4B and 4T was monitored and recorded at specific time intervals during testing. For certain measurements, as described below, a sample S was placed between the bars and the temperature of each bar was measured at set time intervals for standard heating rate. The temperature difference between the two bars was then calculated and is provided in Table 1.

As shown in FIG. 5, a lid L with small wood cleats was closed with a light spring load pressing the stack of bars 4B and 4T with a sample therebetween onto the hotplate HP surface for good thermal contact between all of the components of the stack and the hotplate HP. Before measuring the temperature difference between the two bars, 4B and 4T, a 1 inch×6 inch cavity of the insulation box (not shown) was centered on the hotplate HP surface and covered the bars 4B, 4T and the sample.

During testing, the hotplate HP, bars 4B and 4T, and samples started at room temperature. The hotplate HP was then set to 212° F. (100° C.). The heating rate was controlled by the hotplate HP, which was monitored for consistency of each test by a third thermocouple (not shown) inserted into a fixed position within the HP heating element. Temperature rise of 4B and 4T was recorded at intervals of 4, 12, and 20 minutes. The final temperature difference, ΔT° F., was essentially calculated as 4B° F. minus 4T° F. at 20 minutes and was used as an indicator of the relative insulative characteristics of the samples. Accordingly, a larger ΔT° F. indicated better insulative property. In other words, larger differences in temperature ΔT° F. indicated that bar 4T remained cooler and 4B retained heat. The difference in temperature was due primarily to the thermal insulation characteristic of the interposed sample S, which simulated an insulative factor or the “R” value of a structural member.

Calibration of the testing system was performed periodically to confirm reproducibility of the experimental test method. The heating rate curve of the hotplate was determined to be consistent within the selected 20 minute test duration. Also, all metallic sample surfaces and hotplate HP surfaces were polished with emery for each test to minimize surface oxide accumulation and other interfacial contamination effects on the heat transfer through the bars 4B and 4T and sample S, if any.

Temperature data from calibration of the temperature measurement system and data from measurement of the temperature difference for one sample are compiled in Table 1. As provided in the table, Mode A provided a baseline measurement of the temperature of the bar 4B when subject to heating with the hotplate according to the above procedure. According to the Mode A measurements, the hotplate HP heats most rapidly in the first four minutes, then heats with a more gradual, nearly linear tangential temperature as the set point of 212° F. is approached.

As provided in Table 1, Mode B data provides information regarding the thermal conduction between the two bars 4B and 4T when they are placed in contact with one another and without any material intentionally inserted between them. As noted in Table 1, the heat transfer between the aluminum bars in Mode B is rapid because the two abraded bar surfaces are in direct contact with one another. In Mode C, a specimen of galvanized sheet steel, obtained from Clark-Western Building Systems, Inc. and representing material used for fabrication of metal framing members, was interposed between the bars 4B and 4T. According to the data in Table 1, the ΔT° F. is relatively small, slightly less than about 2 times more than for the very high conductivity aluminum bars. This indicated comparatively rapid heat transfer, as would be expected from the high thermal conductivity of metal. In other words, Mode C data is evidence of the undesirable rapid heat transfer that a galvanized steel wall stud provides between environments having differing temperatures in building structures.

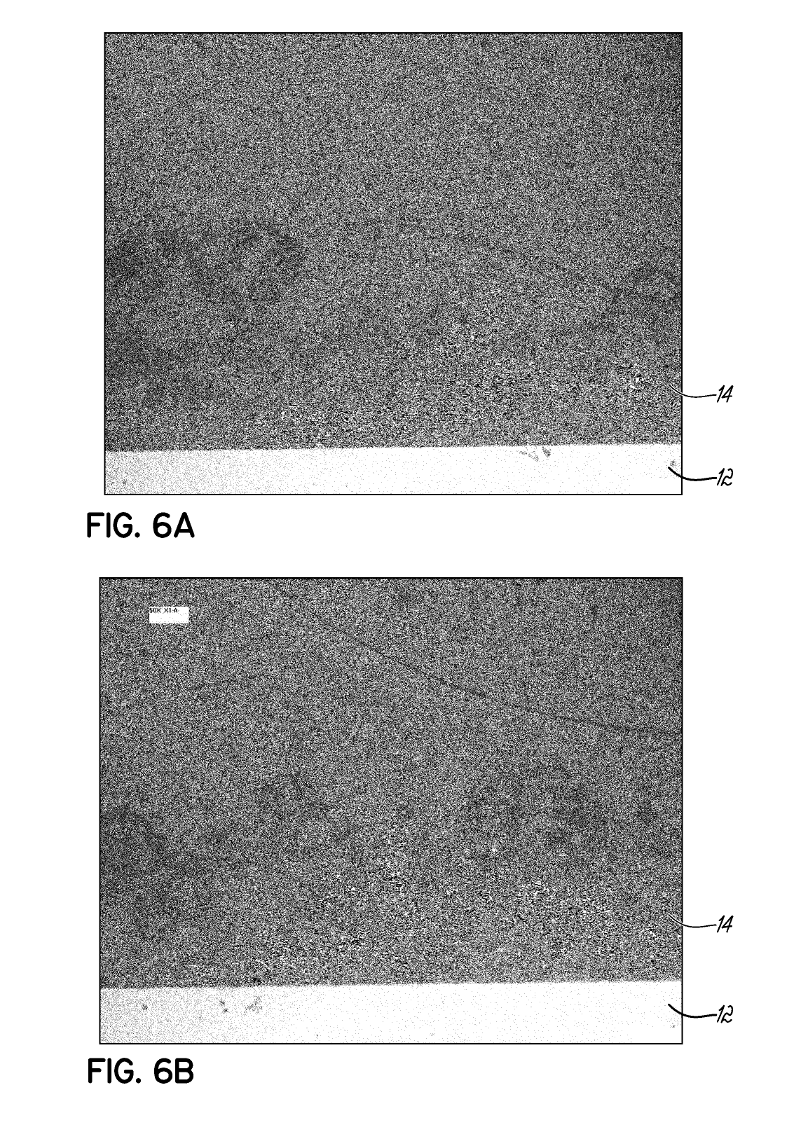

In Mode D, a sample of a polyethylene layer of about 0.082 inch effective bulk thickness on a galvanized steel strip was tested. The coating was applied utilizing an XIOM® X1000™ thermal spray system onto a 1 inch×6 inch strip of about 0.045 inch thick galvanized steel. As indicated in Table 1, the Mode D samples provided an increase of about a factor of 5 times in the ΔT° F. difference in temperature between bar 4B and bar 4T, as compared to the uncoated galvanized steel sample of Mode C. Mode D data demonstrated that a substantial thermal insulative benefit was achieved. Cross sections of the sample were mounted in epoxy for subsequent microscopic examination using traditional metallographic mounting and polishing procedures. FIGS. 6A and 6B are photomicrographs at an original magnification of 50× of two areas of the cross section of the mounted sample. As shown in the photomicrographs, the galvanized metal substrate (labeled 12) had a smooth surface, as no grit blasting or other surface preparation technique was used to prepare its surface before the polyethylene layer was thermally sprayed thereon. The polyethylene layer (i.e., the middle region of the photomicrographs, labeled 14) measured approximately 0.025 inch to approximately 0.040 inch thick depending on the location in the photomicrograph at which the thickness of the layer was measured. However, the bulk thickness as measured with a micrometer was about 0.082 inch. It was observed, therefore, that other, thicker regions of extreme roughness were present in the sample but were not captured in the selected cross section. As shown, the sample had a rough surface texture and was porous, as evidenced by the outer surface of the layer being very irregular when compared to the surface of the metal substrate which was smooth. Furthermore, because the mounting epoxy (i.e., the homogenous upper region of the photomicrographs) penetrated extensively into the layer at various sites of internal porosity, the bulk porosity was estimated to be at least about 50%. The texture and porosity of the layer and the temperature difference across the sample S (i.e., ΔT° F. in Table 1) illustrate two characteristics which were imparted into the thermal sprayed layer to enhance its insulative properties.

Mode E samples were tested to provide temperature difference data for other materials, including air, that were compared to the Mode A-Mode D samples. Mode E samples were performed on materials having known thermal conductivity. Samples in Mode E were 1 inch by 6 inch strips of the material having the thicknesses noted in Table 1. From the data in Table 1, the exemplary sample exhibited ΔT° F. that is of similar magnitude to those materials having known low thermal conductivity values. In essence, this testing demonstrated that the thermally sprayed polyethylene composite layer improved the thermal conductivity of underlying metal substrate and may thereby decrease the costs associated with maintaining the temperature within a building when a structural member, according to the embodiment of the present invention, is used in the construction thereof.

TABLE 1

| | | Separation of Bar | | | |
|---|---|---|---|---|---|
| | | 4B and 4T | ΔT (° F.) | ΔT (° F.)@ | ΔT (° F.)@ |
| | | (Thickness of | @ Elapsed | Elapsed | Elapsed |
| Mode | Sample Description | sample, inches) | Time 4 min. | Time 12 min. | Time 20 min. |
| A | Bar 4B only on | none | 148* | — | 204* |
| | Hotplate | | | | |
| A | Bar 4B only on | none | 142* | 186* | 202* |
| | Hotplate | | | | |
| B | Bar 4T on bar 4B on | no gap | 8 | 6 | 5 |
| | Hotplate | | | | |
| B | Bar 4T on bar 4B on | no gap | 6 | 4 | 4 |
| | Hotplate | | | | |
| C | Galvanized Strip | 0.045 | 14 | 10 | 8 |
| | between bars 4B and | | | | |
| | 4T | | | | |
| C | Galvanized Strip | 0.045 | 11 | 9 | 7 |
| | between bars 4B and | | | | |
| | 4T | | | | |
| D | 0.082″ thick | 0.082 | 38 | 43 | 39 |
| | polyethylene on | | | | |
| | Galvanized Strip | | | | |
| | between bars 4B and | | | | |
| | 4T | | | | |
| D | 0.082″ thick | 0.082 | 36 | 40 | 37 |
| | polyethylene on | | | | |
| | Galvanized Strip | | | | |
| | between bars 4B and | | | | |
| | 4T | | | | |
| E | Acoustic Tile | 0.045 | 45 | 48 | 44 |
| E | Pine Wood | 0.073 | 32 | — | 33 |
| E | Air Gap | 0.083 | 53 | 65 | 60 |

*actual ° F., not ΔT

While the present invention has been illustrated by a description of various embodiments and while these embodiments have been described in some detail, it is not the intention of the Applicants to restrict or in any way limit the scope of the appended claims to such detail. Additional advantages and modifications will readily appear to those of ordinary skill in the art. The various features of the invention may be used alone or in numerous combinations depending on the needs and preferences of the user.

What is claimed is:

1. A structural member for use in constructing a barrier having a covering, said barrier for separating a first environment having a first temperature from a second environment having a second temperature, the structural member comprising:
a core of a first material having a first thermal conductivity, the core being adapted to support the covering and used in constructing the barrier, and
a thermal barrier layer of a second material disposed on at least one exterior surface of the core, the thermal barrier layer having a second thermal conductivity lower than the first thermal conductivity and the thermal barrier layer being positionable between the first environment and the second environment to reduce heat flow between the first and second environments.

2. The structural member of claim 1, wherein the core has a generally rectangular cross-section including a pair of opposing sides, each of the opposing sides defined by a first side edge and a second side edge, and the thermal barrier layer is positioned on at least one of the opposing sides and is defined by a first layer edge and a second layer edge that are substantially coincident with the first and second side edges of the core, respectively.

3. The structural member of claim 1, wherein the core is made of metal or wood.

4. The structural member of claim 1, wherein the thermal barrier layer is made of a polymer.

5. The structural member of claim 1, wherein the thermal barrier layer is at least one of polyethylene, polyurethane, polypropylene, polyamide, polyester, an epoxy, or a combination thereof.

6. The structural member of claim 1, wherein the thermal barrier layer further comprises a third material dispersed in the thermal barrier layer and/or attached to the surface of the thermal barrier layer, the third material having a third thermal conductivity lower than the first thermal conductivity.

7. The structural member of claim 6, wherein the third material is in the form of fibers, particulates, or spheres or a combination thereof.

8. The structural member of claim 1, wherein the thermal barrier layer comprises glass, minerals, ceramics, or combinations thereof.

9. The structural member of claim 1, wherein the thermal barrier layer is spray formed on the core.

10. The structural member of claim 1, wherein an interface between the core and the thermal barrier layer includes an area where the thermal barrier layer and the core are not in contact with one another.

11. The structural member of claim 1, wherein the thermal barrier layer includes internal porosity that is adapted to reduce the thermal conductivity of the thermal barrier layer and includes surface texturing that is adapted to reduce the contact surface area between the covering and the structural member when the covering is secured against the structural member.

12. A method of manufacturing a structural member for use in constructing a barrier having a covering, said barrier for separating a first environment having a first temperature from a second environment having a second temperature, the method comprising:
applying a thermal barrier layer of a first material to a core of a second material, the first material having a thermal conductivity lower than that of the second material, the thermal barrier layer being positionable in the barrier between the first and second environments to reduce heat flow between the first and second environments.

13. The method of manufacturing of claim 12, wherein the core is made of metal.

14. The method of manufacturing of claim 12, wherein the core is made of wood.

15. The method of manufacturing of claim 12, wherein the applying step includes thermal spraying the first material onto the core to form the thermal barrier layer.

16. The method of manufacturing of claim 12, wherein the applying step includes providing a preform of the first material and securing the preform to the core to form the thermal barrier layer.

17. The method of manufacturing of claim 12, wherein the applying step includes attaching a plurality of particles of the first material to the core and the method further comprising heating the core or the particles to melt the particles of the first material to form a layer and cooling the layer to form the thermal barrier layer on the core.

18. The method of manufacturing of claim 12, wherein the applying step includes applying the thermal barrier layer to a preform of the second material and then forming the core from the preform.

19. The method of manufacturing of claim 12, wherein the applying step includes applying the thermal barrier layer to contain a third material dispersed in the thermal barrier layer, the third material having a third thermal conductivity lower than the first thermal conductivity.

20. A system for use in constructing a building and being configured to separate a first environment having a first temperature from a second environment having a second temperature, the system comprising:
a barrier positioned between the first environment and the second environment, said barrier including a plurality of structural members for supporting said barrier and each having a first side and a second side, at least one structural member comprising:
a core of a first material, and
a thermal barrier layer of a second material disposed on the core and coating at least one of the first and second sides of the structural member, the thermal barrier layer having a thermal conductivity less than a thermal conductivity of the first material,
wherein the first side of each structural member is oriented toward the first environment and the second side of the structural member is oriented toward the second environment;
a first barrier covering secured against the first sides of the plurality of structural members; and
a second barrier covering secured against the second sides of the plurality of the structural members, whereby the thermal barrier layer is positioned between at least one of the core and the first barrier covering and the core and the second barrier covering.

21. The system of claim 20, wherein the core has a generally rectangular cross-section having a pair of opposing sides, each of the opposing sides being defined by first and second side edges, and the thermal barrier layer is positioned on at least one of the opposing sides and is defined by a first layer edge and a second layer edge that are substantially coincident with the first and second side edges, respectively.

22. The system of claim 20, wherein the thermal barrier layer is spray formed on the core.

23. The system of claim 20, wherein the thermal barrier layer is made of a polymer.

24. The system of claim 20, wherein the thermal barrier layer is disposed on and coats the first and the second sides of the structural member and wherein each of the first and second barrier coverings are separated from the core by the thermal barrier layer.

25. The system of claim 20, wherein one of the first and second barrier coverings includes a vapor barrier or an air barrier.

26. The system of claim 20, wherein the first and second barrier coverings include dry wall or external insulating sheathing.
